(19) United States
(12) Patent Application Publication
(10) Pub. No.: US 2011/0260618 A1
(43) Pub. Date: Oct. 27, 2011

(54) METHOD AND APPARATUS FOR OPERATING A LIGHTING DEVICE OF A VEHICLE

(75) Inventors: Holger Mueller, Koeln (DE); Sascha Haase, Wermelskirchen (DE); Niels Neibecker, Wermelskirchen (DE)

(73) Assignee: FORD GLOBAL TECHNOLOGIES, LLC, Dearborn, MI (US)

(21) Appl. No.: 13/086,489

(22) Filed: Apr. 14, 2011

(30) Foreign Application Priority Data
Apr. 27, 2010 (DE) 10 2010 016 653.7

(51) Int. Cl. B60Q 1/02

(52) U.S. Cl. 315/83

(57) ABSTRACT

A method of operating an automotive vehicle headlight system switchable between a high-beam state and a low-beam state. The system operates in an automatic mode in which switching between the states is directed based upon signals from a sensor for detecting traffic conditions. The sensor may be a light sensor for detecting the headlights of oncoming vehicles. The vehicle driver may switch the system away from the automatically-determined state to an operator-selected state, and when this occurs the system operates in a manual mode in which switching is not based upon the sensor signals. The system returns to the automatic mode when the automatically-determined state matches the manually-selected state. The system may also return to the automatic mode if there are no further manual actuations by the driver during a selected time interval.

### CROSS-REFERENCE TO RELATED APPLICATIONS

This application claims foreign priority benefits under 35 U.S.C. §119(a)-(d) to DE 10 2010 016 653.7 filed Apr. 27, 2010, which is hereby incorporated by reference in its entirety.

### TECHNICAL FIELD

The invention relates to a method and an apparatus for operating a headlight system of an automotive vehicle.

### BACKGROUND

Automotive vehicles may be equipped with an automatic mode for operation of the head lights to automatically switch the head lights between the normal or low beam condition and the high beam condition. Since many drivers switch on the high beamly rarely, an automatic mode could increase the use time of the high beam and thus improve the night vision of the driver and therefore safety during journeys at night. Secondly, the possibility of manual intervention by the driver is necessary if the high beam is switched on or off in the automatic mode in a manner which is not required or not expected by the driver in a traffic situation.

DE 10 2004 033 705 A1 discloses a motor vehicle with a lighting device with a high beam which can be switched on or off automatically, with the high beam being switched off or on again automatically as a function of a signal from a monitoring device which indicates the presence or absence of oncoming traffic. The driver can turn off the automatic switching operation of the high beam if desired.

DE 10 2005 038 805 A1 discloses a method for automatically switching a high beam and off, in which case the high beam can also be switched on or off in the automatic mode by actuation of a steering column lever provided for manual high beam switching. This results at the same time in the automatic mode being left. In order to reactivate the automatic mode, the lever needs to be actuated again.

In accordance with DE 10 2007 017 028 A1, in a method for operating the lighting device of a road vehicle, the effect of an operation is dependent on a previous state and/or operating mode of the lighting device. If the automatic operating mode is deactivated by an operation for switching on or off the high beam, a further operation is required for reactivating the automatic mode.

It has been shown that, in the known methods, the high beam operation is still used to an insufficient extent. In order to increase traffic safety, it would therefore be desirable to simplify the operation of the lighting device.

### SUMMARY

In a disclosed embodiment, a method of operating an automotive vehicle headlight system having a high-beam state and a low-beam state comprises operating the system in an automatic mode in which switching between the states is directed based upon signals from at least one sensor for detecting traffic conditions. The at least one sensor may be, for example, a light sensor for detecting the headlights of oncoming vehicles. A vehicle operator is able to switch the system away from the automatically-determined state to an operator-selected state, and when this occurs the system operates in a manual mode in which switching is not based upon the sensor signals. The system then returns to the automatic mode when the automatically-determined state matches the manually-selected state.

In another disclosed embodiment, a method of operating a vehicle headlight system having a high-beam state and a low-beam state comprises determining an automatically-determined state based upon signals from at least one sensor detecting traffic conditions, the automatically-determined state being selected from the high-beam state and the low-beam state. Automatic switching is enabled between the high-beam and the low-beam states in accordance with the automatically-determined state. While the automatic switching is enabled, a vehicle operator is allowed to manually switch the system away from the desired state to an operator-selected state. The automatic switching between the states is then re-enabled when the automatically-determined state matches the manually-selected state.

In another disclosed embodiment, a method of operating a vehicle headlight system having a high-beam state and a low-beam state comprises operating an electronic controller to determine an automatically-determined state based upon signals from at least one sensor detecting traffic conditions, the automatically-determined state being selected from the high-beam state and the low-beam state; operating the electronic controller in an automatic mode wherein automatic switching between the high-beam and the low-beam states occurs in accordance with the automatically-determined state; allowing an operator to manually switch the system away from the desired state to an operator-selected state; and re-enabling the automatic mode when the automatically-determined state matches the manually-selected state.

### BRIEF DESCRIPTION OF THE DRAWINGS

The invention will be explained in more detail by way of example below with reference to the drawings, in which:

FIG. 1 shows a basic circuit diagram for switching between the automatic mode and the manual mode;

FIG. 2 shows a basic circuit diagram for switching between the high beam and low beam states; and

FIG. 3 shows an illustration of the desired state and the actual state of the high beam and the effectiveness of the automatic mode in a typical traffic situation.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

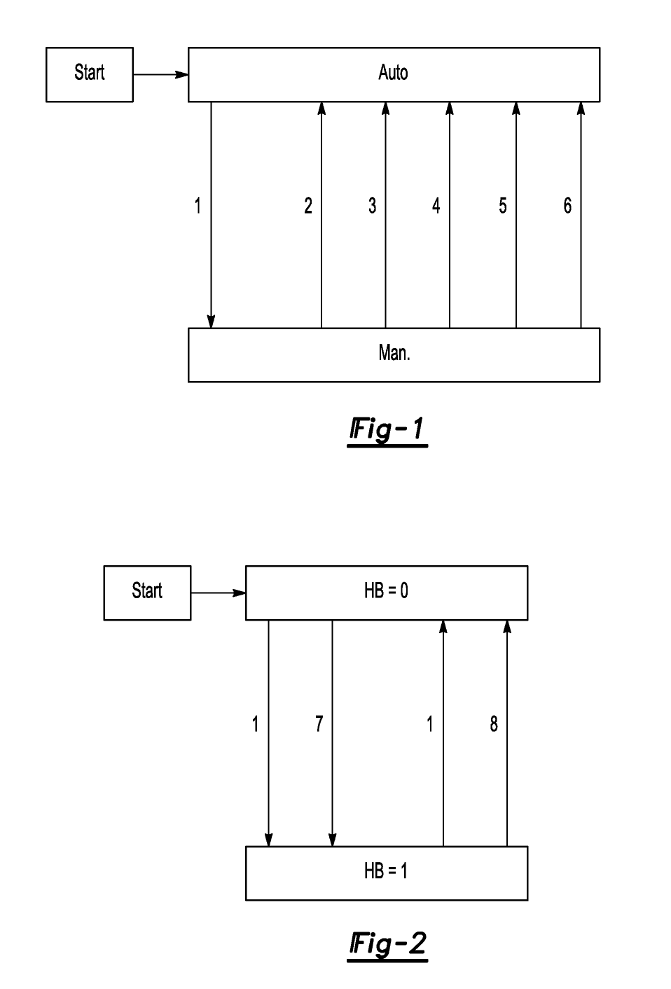

As shown in FIG. 1, a headlight system for an automotive vehicle is operable in either an automatic mode 10 or in a manual mode 20 to control switching the system between a high-beam state and a low-beam state. The phrases “between a high-beam state and a low-beam state,” “between the states,” and any similar phrase used throughout this document is meant to include switching or changing in both directions; i.e., from high-beam to low-beam and from low-beam to high-beam. The system initially enters the automatic mode 10 when the headlight system is switched ON, or when the motor vehicle engine is started, or when electrical power is applied to the vehicle systems. In this way, automatic switching between low- and high-beams is immediately available with all of its benefits.

In the automatic mode, the headlight(s) may be switched between low- and high-beam by an electronic controller (executing appropriate control logic) on the basis of signals from a traffic condition sensor, as is well known in the art, for example in the event of a pre-determined limit brightness in the surrounding environment being undershot. Also or alternatively, in the automatic mode the headlight(s) may be controlled on the basis of position data of the vehicle from a navigation system indicating a tunnel, for example, or an urban traffic area. For example, provision can be made for system to always switch from high-beam to low-beam when entering an urban traffic environment. Owing to the fact that the automatic mode becomes effective without any additional operation by the driver when the headlights are switched on, further simplified operation and maximized use time of the automatic mode are achieved.

If, for example, the controller determines based on the sensor(s) signals that there is no other vehicle in front of the vehicle, which means that the preconditions required for the use of the high beam are met, the automatically-determined state of the high beam is “on”, and the high beam is automatically switched on. If, on the other hand, for example, oncoming traffic has been detected, which means that these preconditions do not exist, the automatically-determined state is “off”, and the high beam is automatically switched off.

While operating in the automatic mode, the vehicle operator may manually switch the system from the automatically-determined state to the other/opposite state by actuating a control element (arrow 1). The state of the headlights can thus be altered by manual operation in such a way that would generally therefore deviate from the automatically-determined state. The manual operation has precedence over the automatic mode. By such a manual switching, therefore, the automatic mode is overridden or interrupted and the manual mode becomes effective. The term “manual” in the context of this document includes any manner of command that may be purposefully made by the vehicle operator to cause a non-automatic change from one state to the other and may include, for example, a voice command. As a result, for example, the operator may select the high-beam state when the automatically-determined state is low-beam, or the operator may select low-beam when automatically-determined state is high-beam.

The possibility of manual actuation is necessary for safety reasons and at least for the case in which the preconditions for the use of the high beam have been determined incorrectly or the automatically determined state does not correspond to that expected by the driver.

At the same time, the manual state-change made by the operator causes the system to change from the automatic mode to the manual mode. In the manual mode, the switching of the headlight system is determined by the manual actuation(s) made by the operator rather than being automatically controlled based upon conditions detected by sensors. While in the manual mode, the system continues to determine an automatically-determined state. The headlights, however, are not automatically switched to this automatically-determined state, but rather remain in the operator-selected state until the system returns to the automatic mode.

The system reverts back to the automatic mode as shown in FIG. 1 when at least one of the following conditions is present:
The automatically determined state is “high beam” and the state selected by manual switching is also “high beam” (arrow 2).
The automatically determined state is “low beam” and the state selected by manual switching is also “low beam” (arrow 3).
A predetermined delay time has elapsed without any further manual actuation having been made by the operator after the manual switching operation (arrow 4).
A change to the automatic mode is brought about by other input signals, for example when entering urban traffic which can be determined, for example, from data from a GPS-supported navigation system (arrow 5).
In addition, a manual changeover to the automatic mode can be possible, for example as a result of renewed actuation of the operating element (arrow 6). Owing to the fact that manual actuation can be used to change over to the automatic mode, the automatic mode can be made effective irrespective of the actual state and the desired state of the high beam. As a result, further improved use of the automatic mode is possible.

If “low beam” has been selected manually from the automatic mode in the state “low beam” or “high beam” has been selected from the automatic mode in the state “high beam”, the system reverts back to the automatic mode immediately and this automatic mode is not interrupted.

As indicated by arrows 2 and 3 of FIG. 1, after a manual operation, there is an automatic return to the automatic mode when the present state achieved by the manual operation corresponds to the automatically-determined state determined by the controller. For this purpose, a automatically-determined state continues to be determined, even when the automatic mode has been interrupted due to a manual intervention/actuation having been performed, and is compared with the state selected by the manual intervention. As soon as the two states correspond to one another, the system returns to the automatic mode of operation. Since the automatic mode would therefore at this point in time produce that state of the high beam which has already been manually triggered by the driver, there is no change in the state when reverting back to the automatic mode. The automatic mode only has an effect on the state of the high beam again when a subsequent change in the automatically-determined state is determined by the controller and the system is switched automatically to that desired state.

Because the system automatically returns to the automatic mode after a manual switching of the high beam, no action by the driver is required in order to return to the automatic mode. In addition, at this time there is no difference for the driver from the usual manual switching response owing to the fact that, when the manually switched state and the automatically determined desired state correspond to one another, there is a return to the automatic mode. The method therefore enables simple and intuitive operation and at the same time enables virtually continuous use of the automatic mode and optimum use of the high beam, without burdening the driver with additional switching operations.

As is shown in FIG. 2, when the automatic mode is started, which takes place, for example, when the motor vehicle is started or when the headlights are initially switched on, provision can first be made for the system to enter the low-beam state (HB=0). A change from the state “low beam” (HB=0) to the state “high beam” (HB=1) can take place a) manually by the driver actuating a control element, for example a light control lever, button, or switch on the steering column, or a voice command (arrow 1′), and b) in the automatic mode as a result of a change in the automatically determined state if, for example, there is no longer an oncoming vehicle detected by a sensor (arrow 7). Conversely, there can be a changeover from the state “high beam” (HB=1) to the state “low beam” (HB=0) both a) manually by actuation of a control element by the driver, and b) automatically on the basis of a change in the automatically-determined state if, for example, an oncoming vehicle is detected (arrow 8).

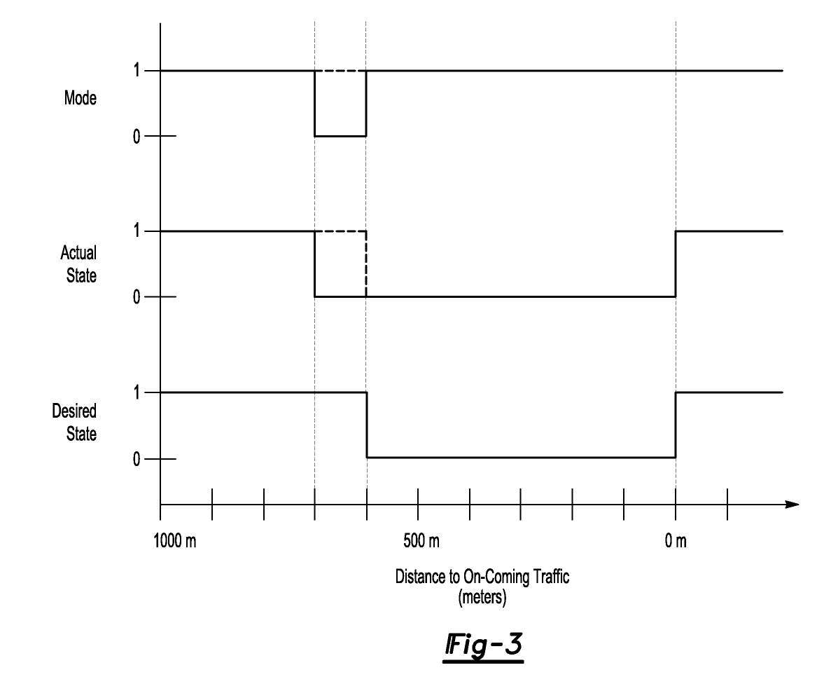

FIG. 3 illustrates the states in a typical driving situation. The top-most of the three traces is the operating mode of the headlight system, with 1=Automatic Mode and 0=Manual Mode. The bottom-most of the three traces is the “Desired” state which is the automatically-determined state determined, for example, by an electronic controller based upon traffic sensor signals. The value 1 indicates the high-beam state and the value 0 indicates the low beam state. The center trace is the actual operating state of the headlights, 1=high beam and 2=low beam.

At a relatively large distance from an oncoming vehicle, the automatically-determined (or Desired) state is “high beam” (Desired=1) since the oncoming vehicle is still at a distance which is sufficient for there to be no impairment of the vision of the oncoming vehicle's driver as a result of the high beam. So long as the automatic mode is effective (Mode=1, top-most trace in FIG. 3), the actual state of the system is “high beam” (Actual State=1, middle trace in FIG. 3).

If the distance to oncoming vehicle decreases and there is no intervention by the driver, the other vehicle will be detected automatically, for example with the aid of a camera or other light sensor, and the desired state changes to “low beam” (Desired=0) at a range at which vision impairing glare is possible, for example at 600 meters. Owing to the automatic mode being in effect (Mode=1, dotted line in the top trace in FIG. 3), the headlights are switched to low beam at this point in time (Actual State=0, dotted line in the middle trace). Once the oncoming vehicle has driven past the host vehicle (distance=0), the desired state is set to “high beam” (Desired=1) again on the basis of a corresponding light sensor signal. Correspondingly, the high beam is switched on again (Actual State=1) on the basis of the effective automatic mode.

If, in contrast to the above example, there is an intervention by the driver as the oncoming vehicle approaches, that is if the driver wishes to switch off the high beam, for example at a distance of 700 m even though the high beam has not yet been switched off in the automatic mode, this can take place by manual actuation of the control element. As is shown in FIG. 3, the actual state of the high beam is thus switched from “high beam” (Actual State=1) to “low beam” (Actual State=0) (solid line in the middle trace of FIG. 3). At the same time, the automatic mode is cancelled (Mode=0, solid line in the top-most trace). The automatically-determined (“Desired”) state is not changed in any way, as shown by the solid line between 700 m. and 600 m. maintaining value 1 , or High Beam, in the middle trace.

As the oncoming vehicle approaches nearer, the oncoming vehicle is automatically detected at a certain distance if vision impairment is possible, with the result that the desired state changes from “high beam” (Desired State=1) to “low beam” (Desired State=0). Now, the desired state matches or corresponds to the actual state again, with the result that the automatic mode becomes effective again (Mode=1, solid line in the top-most trace). If the oncoming vehicle is no longer detected (at distance=0, as shown, or if the vehicle turns off of an approaching path), the Desired state is set back to “high beam” (Desired State=1), as in the previous example and the high beam is switched on (Actual State=1)

No manual intervention is therefore required for the system to return back to the automatic mode. Because the system automatically returns to the automatic mode, no action by the driver is required in order to return to the automatic mode. In addition, at this time there is no difference for the driver from the usual manual switching response owing to the fact that, when the manually switched state and the automatically determined state correspond to one another, there is a return to the automatic mode. The method therefore enables simple and intuitive operation and at the same time enables virtually continuous use of the automatic mode and optimum use of the high beam, without burdening the driver with additional switching operations.

As mentioned above in relation to arrow 5 in FIG. 1, the system may further return to the automatic mode when a predetermined time has elapsed without any further manual switching having been performed by the operator. For this purpose, it is not necessary for the actual state of the high beam to correspond to the automatically-determined state. This means that even in a case in which the state of the system selected by the driver probably no longer corresponds to the present traffic situation, there is a change to the automatic mode without any manual actuation by the driver. In particular, very extensive use of the automatic mode and optimum use of the high beam can thus be ensured even when the driver has forgotten that he has switched the high beam on or off manually and thereby overridden the automatically-determined state.

Advantageously, the delay time after which the system returns to the automatic mode even when the present state of the high beam does not correspond to the desired state can be set by an operator, in particular by the driver. It is thus possible to achieve a situation in which the operator can set the conditions for automatically reverting to the automatic mode in accordance with his expectations, which can result in further simplified and intuitive operation. The switching time may also be dependent on other driving parameters, for example on the vehicle's present speed, with the result that the typical duration of a lower-beam situation characterized by the presence of oncoming traffic can be taken into consideration.

An apparatus for operating a headlight system of an automotive vehicle, the headlight system being operable in a high-beam state and a low-beam state, comprises an electronic controller, which is designed to determine a desired state of the headlights based upon input signals from one or more sensors, such a photo sensors, distance sensors, and/or location sensors. The controller may operate in an automatic mode wherein the operating state of the headlights is automatically set or switched to the desired state.

The apparatus further comprises a driver-operated control device for manually switching between high- and low-beam. Accordingly, the electronic controller may operate in a manual mode wherein switching between the high- and low-beam states is based on a switching signal from the driver-actuated control device rather than the sensor input signals. The switching signal from the driver-operated control device has precedence over the automatic mode, with the result that the automatic mode is interrupted by the manual switching signal. The system reverts back to the automatic mode as soon as the state selected by the manual operation matches to the desired state. As a result, intuitive and particularly simple operation of the high beam alongside optimum use of the automatic mode is achieved.

The input signal generated by the sensor(s) enable the identification of traffic conditions, for example identification of oncoming traffic or vehicles travelling in front, in particular within a predetermined distance or angular range. For this purpose, optical sensors, in particular a camera, or else radar or infrared sensors can be provided, for example. The input signal generated by the sensor(s) makes it possible to establish whether the conditions for switching between high beam are low beam are present, and to determine the desired state on the basis of this. The electronic controller is preferably designed to implement data processing and/or image analysis operations required for determining the desired state of the headlights from the input signal.

The apparatus may further comprise visual indicator means for indicating functioning of the system in the automatic mode. As a result, it is possible for a driver to identify the operating mode in which the control device is functioning at present. As a result, the driver is able at any time to identify whether the control device is operating in the automatic mode or in the manual mode to correspondingly perform further operations, if required.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of operating an automotive vehicle headlight system having a high-beam state and a low-beam state, comprising:
operating the system in an automatic mode in which switching between the states is directed based upon signals from a sensor for detecting traffic conditions;
when an operator switches the system away from the automatically-determined state to an operator-selected state, operating the system in a manual mode in which switching is not based upon the sensor signals; and
returning the system to the automatic mode when the automatically-determined state matches the manually-selected state.

2. The method of claim 1 wherein the system enters the automatic mode when the headlight system is initially turned on.

3. The method of claim 1 wherein the system returns to the automatic mode after a delay time has elapsed since entering the manual mode without further switching having been performed by the operator.

4. The method of claim 3 wherein the delay time is set by the operator and/or is dependent on present driving parameters.

5. The method of claim 1 wherein the operator may manually return the system to the automatic mode.

6. The method of claim 1 wherein, when operating in the automatic mode, the system switches from the high-beam state to the low-beam state based upon an input from a second sensor.

7. The method of claim 6 wherein the second sensor input is related to vehicle location.

8. A method of operating a vehicle headlight system having a high-beam state and a low-beam state, comprising:
determining an automatically-determined state based upon signals from a sensor detecting traffic conditions, the automatically-determined state being selected from the high-beam state and the low-beam state;
enabling automatic switching between the high-beam and the low-beam states in accordance with the automatically-determined state;
allowing an operator to manually switch the system away from the desired state to an operator-selected state; and
re-enabling automatic switching between the states when the automatically- determined state matches the manually-selected state.

9. The method of claim 8 wherein the enabling of automatic switching begins when the headlight system is initially turned on.

10. The method of claim 8 wherein the automatic switching is further re-enabled after a delay time has elapsed since the operator has made a manual switch between states.

11. The method of claim 10 wherein the delay time is set by the operator and/or is dependent on present driving parameters.

12. The method of claim 8 wherein the operator may manually re-enable the automatic switching.

13. The method of claim 8 wherein, when the automatic switching is enabled, the system switches from the high-beam state to the low-beam state based upon an input from a second sensor.

14. The method of claim 13 wherein the second sensor input is related to vehicle location.

15. A method of operating a vehicle headlight system having a high-beam state and a low-beam state, comprising:
operating an electronic controller to determine an automatically-determined state based upon signals from a sensor detecting traffic conditions, the automatically-determined state being selected from the high-beam state and the low-beam state;
operating the electronic controller in an automatic mode wherein automatic switching between the high-beam and the low-beam states occurs in accordance with the automatically-determined state;
allowing an operator to manually switch the system away from the desired state to an operator-selected state; and
re-enabling the automatic mode when the automatically-determined state matches the manually-selected state.

16. The method of claim 15 wherein the system enters the automatic mode when the headlight system is initially turned on.

17. The method of claim 15 wherein the automatic mode is re-enabled after a delay time has elapsed since the operator has made a manual switch without further switching having been performed by the operator.

18. The method of claim 15 wherein the operator may manually return the system to the automatic mode.

19. The method of claim 15 wherein, when operating in the automatic mode, the system switches from the high-beam state to the low-beam state based upon an input from a second sensor.

20. The method of claim 19 wherein the second sensor input is related to vehicle location.
